(19) United States
(12) Patent Application Publication
(10) Pub. No.: US 2009/0110630 A1
(43) Pub. Date: Apr. 30, 2009

(54) METHOD OF MANUFACTURING VANADIUM OXIDE NANOPARTICLES

(75) Inventors: Chul Tack LIM, Suwon (KR); Chang Hwan CHOI, Seongnam (KR); Byoung Jin CHUN, Suwon (KR); Jin Hyuck YANG, Seoul (KR); Takaki MASAKI, Wonju (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD

(21) Appl. No.: 12/247,550

(22) Filed: Oct. 8, 2008

(30) Foreign Application Priority Data
Oct. 25, 2007 (KR) 10-2007-0107756

(51) Int. Cl. C01G 31/02

(52) U.S. Cl. 423/594.17

(57) ABSTRACT

Disclosed is a method of manufacturing vanadium oxide nanoparticles, which can prepare vanadium oxide particles having a size of tens of nanometers with high yield by using a simple, low-cost process. The method of manufacturing vanadium oxide nanoparticles includes preparing a solution containing a vanadium salt; impregnating an organic polymer including a nanosized pore with the prepared solution; and heating the organic polymer impregnated with the vanadium salt solution until the organic polymer is fired.

### CROSS-REFERENCE TO RELATED APPLICATIONS

This application claims the priority of Korean Patent Application No. 2007-107756 filed on Oct. 25, 2007, in the Korean Intellectual Property Office, the disclosure of which is incorporated herein by reference.

### BACKGROUND OF THE INVENTION

1. Field of the Invention

The present invention relates to a method of manufacturing vanadium oxide nanoparticles, and more particularly, to a method of manufacturing vanadium oxide nanoparticles, which can prepare vanadium oxide particles having a size of tens of nanometers with high yield by using a simple, low-cost process.

2. Description of the Related Art

As products are developed to have smaller sizes and slimmer profiles with higher capacity, a process of preparing fine particles of a raw material becomes more important and is considered as a core technique in a product manufacturing process.

For example, when a multilayer ceramic capacitor (MLCC) is manufactured, barium titanate (BaTiO₃) is used as a main component of a dielectric, and an additive (mainly, a metal oxide) is also used to affect chip characteristics of the MLCC. To increase electrostatic capacitance of the MLCC, not only the barium titanate but also the additive needs to be prepared as fine particles, uniformly dispersed as primary particles and stably maintain their dispersion state.

In due consideration of the fact that an average particle size of the barium titanate being widely used in a slim and high capacity MLCC is about 150 nm, an additive must have a particle size of tens of nanometers to desirably coat a surface of the barium titanate. Also, to manufacture the slim and high capacity MLCC, composition uniformity of an internal electrode and a dielectric layer must be maintained, and pore formation in the dielectric must be prevented. Thus, the main component of the dielectric and the additive must be prepared as fine particles and dispersion thereof must be stabilized.

Vanadium oxide may be used as an additive in manufacturing the MLCC. The vanadium oxide serves as a catalyst for low-melting-point liquid phase sintering, together with silicon (Si) or calcium (Ca). The vanadium oxide may also serve to inhibit growth of another particle. The vanadium oxide may be applied in the form of a porous dried gel to a humidity sensor, an optical memory, a photochromatic device, a secondary battery or the like.

An example of a method of manufacturing vanadium oxide includes a top-down method. In the top-down method, a vanadium oxide precursor having a primary average particle size ranging from about 100 nm to about 200 nm is made into slurry and the slurry is ground into smaller particles by using a grinding machine. That is, in the top-down method, powder having a particle size greater than a desired particle size is ground into smaller-sized particles.

If a particle size of the vanadium oxide precursor is small, particles having a size of tens of nanometers can be easily obtained, but the precursor is undesirably expensive. If a precursor with a great particle size is used, a grinding process for obtaining smaller particles is complicated. Also, even after the grinding process, the ground particles may have undesired shapes or aggregate with one another. Thus, it is difficult to prepare particles having a desired shape and a size of about tens of nanometers.

To cope with the aforementioned limitations, an aerosol method or a method of decomposing a precursor with microwave plasma has been proposed for preparation of vanadium oxide. However, the proposed methods have limitations in particle-size control since they are also the top-down method employing a principle of grinding powder into smaller particles.

Even if the vanadium oxide is used as an additive in smaller amount as compared to another raw material as in the MLLC, the vanadium oxide is an essential additive having a significant effect for its added amount. Thus, the vanadium oxide significantly affects the overall performance or quality of a product.

However, it is difficult to prepare vanadium oxide particles that have a desired shape and a size of tens of nanometers by using the related art method. Therefore, there is a need for a simpler process by which vanadium oxide particles having a desired size and shape can be prepared.

### SUMMARY OF THE INVENTION

An aspect of the present invention provides a method of manufacturing vanadium oxide nanoparticles, which can prepare vanadium oxide particles having a size of tens of nanometers with high yield by using a simple, low-cost process.

According to an aspect of the present invention, there is provided a method of manufacturing vanadium oxide nanoparticles, including: preparing a vanadium salt solution by dissolving a vanadium salt in a solvent; impregnating an organic polymer including a nanosized pore with the vanadium salt solution; and heating the organic polymer impregnated with the vanadium salt solution until the organic polymer is fired. The vanadium salt may have an oxidation number of one of +2, +3, +4 and +5. The vanadium salt solution may be a vanadyl sulfate (VOSO4) solution. The vanadium salt solution may have a concentration ranging from 5 wt % to 15 wt %.

When the organic polymer is impregnated with the solution containing the magnesium salt, heating may be performed to fire the organic polymer. The heating the organic polymer may be performed at a temperature ranging from 300° C. to 600° C. The heating the organic polymer may be continued for 30 minutes to 5 hours. The heating the organic polymer may be performed at a heating rate of 2° C./h to 20° C./h.

The pore of the organic polymer may have a size on a nanoscale, ranging from 1 nm to 9 nm. The vanadium oxide nanoparticles manufactured by the method of manufacturing vanadium oxide nanoparticles may have a size ranging from 50 nm to 90 nm.

The method may further include drying the organic polymer impregnated with the vanadium salt solution before the heating the organic polymer.

The method may further include milling a heating residue after the heating the organic polymer.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view showing that vanadium oxide particles are trapped within respective pores of an organic polymer according to an embodiment of the present invention;

FIGS. 2A and 2B illustrate surface images of vanadium oxide nanoparticles manufactured by the method of manufacturing vanadium oxide nanoparticles according to the embodiment of the present invention;

FIG. 3 is a graph showing XRD data of vanadium oxide nanoparticles manufactured by the method of manufacturing vanadium oxide nanoparticles according to the embodiment of the present invention; and

FIG. 4 is a graph showing a result of particle-size analysis of vanadium oxide nanoparticles manufactured by the method of manufacturing vanadium oxide nanoparticles according to the embodiment of the present invention.

### DETAILED DESCRIPTION OF THE PREFERRED EMBODIMENT

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

A method of manufacturing vanadium oxide nanoparticles according to an embodiment of the present invention includes preparing a vanadium salt solution by dissolving a vanadium salt in a solvent; impregnating an organic polymer having a nanosized pore with the vanadium salt solution; and heating the organic polymer impregnated with the vanadium salt solution until the organic polymer is fired.

First, to prepare vanadium oxide, a solution containing a vanadium salt (hereinafter, referred to as a vanadium salt solution) is prepared. Vanadium may have various oxidation numbers. The oxidation number of the vanadium salt may be one of +2, +3, +4 and +5. The oxidation number of the vanadium salt may be varied according to process conditions such as a process temperature, a vanadium salt concentration or a firing temperature. The prepared vanadium oxide includes vanadium oxide having an oxidation number of the most stable state, but vanadium oxide with an oxidation number of a less stable state may also be prepared. The most stable vanadium oxide is divanadium pentoxide (V₂O₅).

The vanadium salt used in the current embodiment of the present invention is not particularly limited. However, the vanadium salt solution must be used for impregnation of an organic polymer and the vanadium salt must be oxidized to vanadium oxide at a firing temperature of the organic polymer.

The solvent may be water or an organic solvent. When the solvent is water, the vanadium salt solution may include sulfuric acid. In this case, the vanadium salt solution may be a vanadyl sulfate (VOSO₄) aqueous solution. The concentration of the solution may be determined in due consideration of a pore characteristic of the organic polymer to be integrated and dispersion of resultant nanoparticles. The concentration of the VOSO₄ aqueous solution may range from 5 wt % to 15 wt %.

If the concentration of the vanadium salt is lower than 5 wt %, the amount of vanadium salt acting as a precursor of vanadium oxide is insufficient, resulting in low yield of the vanadium oxide, which is an end product. If the concentration of the vanadium salt exceeds 15 wt %, a disparity between a limited number of pores of the organic polymer and the number of nanoparticles to be trapped therein may occur. The excessively generated nanoparticles may undesirably aggregate with one another.

After the vanadium salt solution is prepared, the organic polymer having nanosized pores is impregnated with the vanadium salt solution. For example, the organic polymer may have pores of a predetermined size, such as a pulp type fiber texture. Particularly, the organic polymer usable in the current embodiment of the present invention may have nanosized pores. The organic polymer may be cellulose which is an organic compound in plants. The cellulose has chemical formula (C₆H₁₀0₆)ₙ, and generates carbon dioxide (CO₂) and water (H₂O) when heated.

The term ‘nanosized’ in the ‘nanosized pores’ refers to a size of a few nanometers. A vanadium salt, which is a precursor of vanadium oxide, is trapped within the nanosized pores of the organic polymer before the vanadium salt becomes the vanadium oxide. Thus, the prepared vanadium oxide has a size of tens of nanometers. Hence, the pore size of the organic polymer may range from 1 nm to 9 nm.

According to the current embodiment of the present invention, to prepare vanadium oxide, the organic polymer with nanosized pores is impregnated with the solution containing a vanadium salt, and nanosized vanadium salt particles are trapped within the respective pores of the organic polymer.

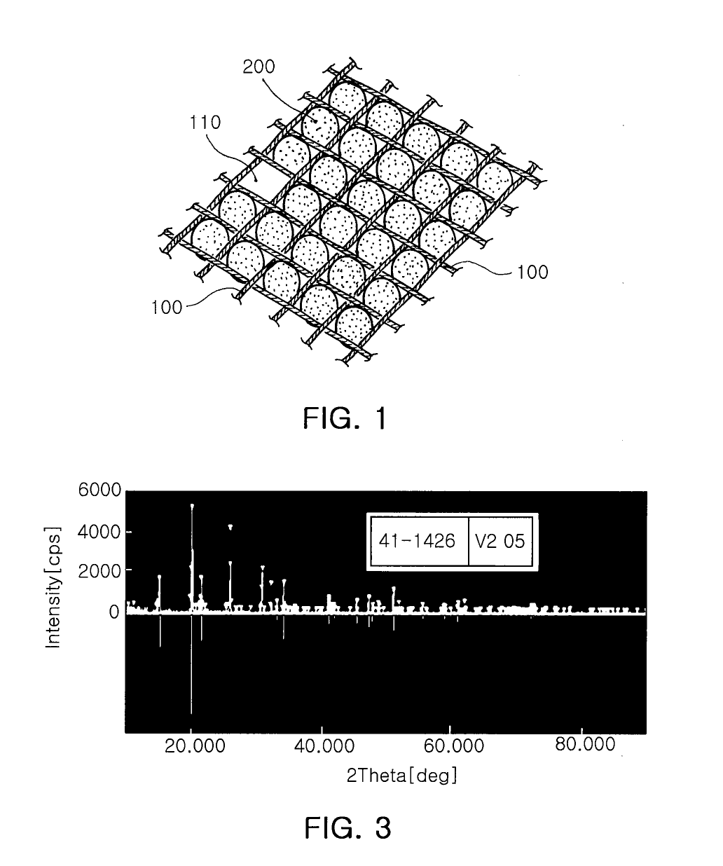

FIG. 1 is a view showing that vanadium salt particles 200 are trapped within respective pores 110 of an organic polymer 100 according to the embodiment of the present invention. The vanadium salt particles 200 exist in the size of a few nanometers, trapped within the respective nanosized pores 110 of the organic polymer 100. Since the vanadium salt particles 200 are respectively trapped within the pores 110 of the organic polymer 100, the vanadium salt particles 200 do not aggregate at the time of reaction. Since the precursor itself has a size of a few nanometers, vanadium oxide particles being prepared can have the size of tens of nanometers.

The vanadium oxide nanoparticles prepared by the above method of manufacturing vanadium oxide nanoparticles according to the current embodiment have a size of tens of nanometers. For example, the vanadium oxide nanoparticle may have a size ranging from 50 nm to 90 nm.

After the organic polymer is impregnated with the vanadium salt solution, the impregnated organic polymer is heated. As mentioned above, when heated, the organic polymer (e.g., C₆H₁₀0₆)ₙ generates CO₂ and H₂O. Thus, the organic polymer can be removed by heating.

The organic polymer impregnated with the vanadium salt solution may be heated at a temperature ranging from 300° C. to 600° C. for 30 minutes to 5 hours. Also, the heating may be performed at a heating rate of 2° C./h to 20° C./h.

The method of manufacturing vanadium oxide nanoparticles according to the current embodiment of the present invention may further include drying the organic polymer impregnated with the vanadium salt solution before the heating of the impregnated organic polymer. If the organic polymer is impregnated with an excessive amount of vanadium salt, a vanadium crystal or vanadium salt larger than the nanoscale may be generated on a surface of the organic polymer. Therefore, the drying method or another method may be used to remove the excessive amount of vanadium salt solution.

The method of manufacturing vanadium oxide nanoparticles according to the current embodiment of the present invention may further include cooling a heating residue after the heating of the organic polymer and milling the cooled heating residue. That is, after the vanadium oxide nanoparticles of tens of nanometers are manufactured by using the organic polymer, the milling may be performed to prepare vanadium oxide nanoparticles having a uniform size.

Vanadium oxide powder, which is a heating residue, may be obtained when the organic polymer is fired by the heating of the organic polymer impregnated with the vanadium salt solution. This powder is dispersed in a predetermined solvent and then milled. If it is difficult to disperse the powder in the predetermined solvent, a dispersant such as a surfactant is used. The predetermined solvent may be ethanol, which is a non-aqueous solvent. The surfactant may be an organic polymer-based surfactant.

After the milling, particle-size analysis is performed. If the analysis reveals that vanadium oxide particles with a desired size and shape are prepared, the milling is stopped, and the vanadium oxide nanoparticles are collected.

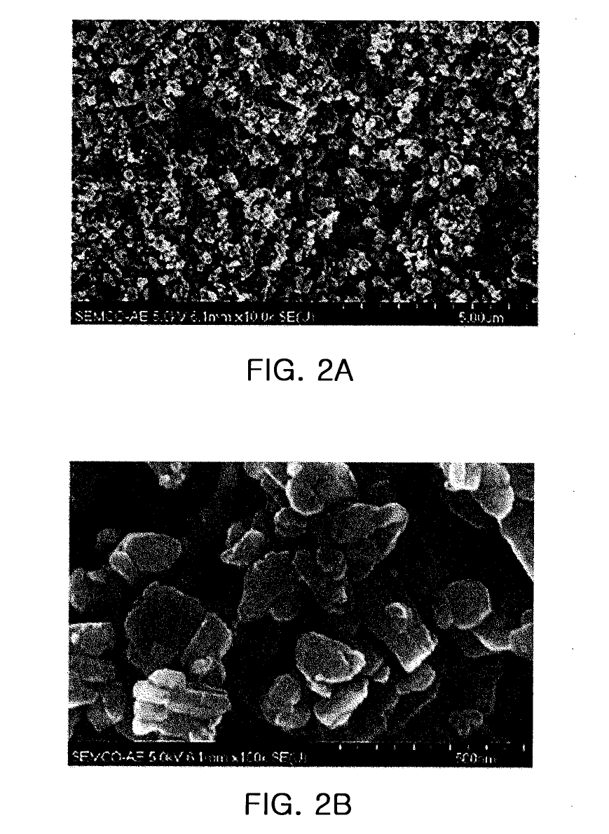

FIGS. 2A and 2B are field emission scanning electron microscope (FE-SEM) images of vanadium oxide nanoparticles manufactured by the method of manufacturing vanadium oxide nanoparticles according to the current embodiment of the present invention. The image of FIG. 2B is a higher resolution image than that of FIG. 2A.

Referring to FIGS. 2A and 2B, it can be seen that the vanadium oxide nanoparticles manufactured according to the current embodiment of the present invention have relatively uniform shapes. Also, it can be seen that particles are clearly distinguished from one another and act as individual nanoparticles.

FIG. 3 is a graph showing XRD data of the vanadium oxide nanoparticles of FIGS. 2A and 2B. Referring to FIG. 3, it can be seen that the nanoparticles manufactured by the method of manufacturing vanadium oxide nanoparticles according to the current embodiment of the present invention is vanadium oxide, particularly, stable V₂O₅.

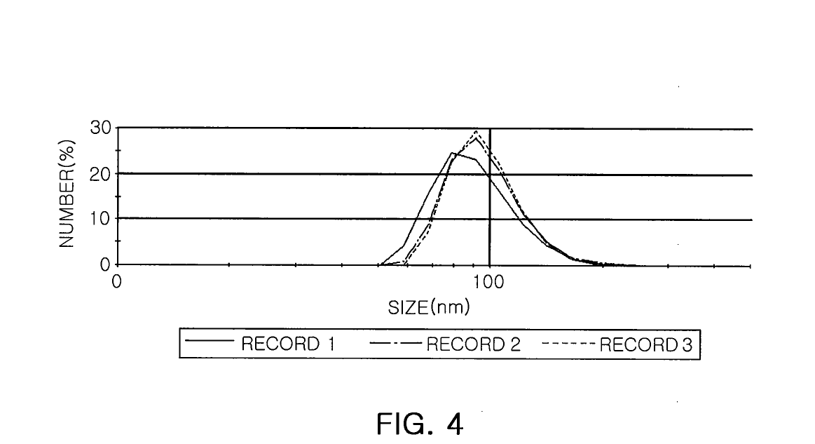

FIG. 4 is a graph showing a result of particle-size analysis of vanadium oxide nanoparticles manufactured by the method of manufacturing vanadium oxide nanoparticles according to the current embodiment of the present invention. The particle-size analysis is performed three times on the same vanadium oxide nanoparticles, and average particle-sizes are calculated. The result is shown in the following Table 1.

TABLE 1

Cumulative number
of particles (%)

| | 10 | 50 | 90 | 99.9 |
|---|---|---|---|---|
| Record 1 | 66.1 | 88 | 127 | 220 |
| Record 2 | 71.2 | 93.1 | 129 | 210 |
| Record 3 | 72.7 | 93.8 | 128 | 198 |
| Average | 70.0 | 91.8 | 128 | 209 |

Referring to Table 1, 50% of the vanadium oxide nanoparticles manufactured according to the present invention have a size smaller than 91.8 nm. Also, 10% to 50% of the vanadium oxide nanoparticles have a size of about 70 nm to about 90 nm. Thus, it can be seen that uniform vanadium oxide nanoparticles are generated.

Hence, it is confirmed that vanadium oxide nanoparticles each of which has a distinctive shape and an average size of about 90 nm are manufactured according to the embodiment of the present invention.

According to the present invention, nanoparticles of a metal oxide such as magnesium (Mg), dysprosium (Dy) or yttrium (Y) can be also obtained with high yield by the same method. Also, if an oxide is prepared using at least two materials selected among V, Mg, Dy and Y by the method of manufacturing nanoparticles according to the present invention, nanoparticles of a composite metal oxide can be obtained. Like vanadium oxide, an oxide of Mg, Dy or Y is used usefully as an additive for a dielectric composition of a capacitor.

As described so far, according to the present invention, vanadium oxide particles having a size of tens of nanometers can be effectively manufactured by using a low-priced precursor.

Also, uniform vanadium oxide nanoparticles with desired shapes can be manufactured by controlling the shapes of the vanadium oxide nanoparticles of tens of nanometers. Also, the vanadium oxide nanoparticles can be obtained with high yield by using a simple process.

While the present invention has been shown and described in connection with the exemplary embodiments, it will be apparent to those skilled in the art that modifications and variations can be made without departing from the spirit and scope of the invention as defined by the appended claims.

What is claimed is:

1. A method of manufacturing vanadium oxide nanoparticles, the method comprising:
preparing a vanadium salt solution by dissolving a vanadium salt in a solvent;
impregnating an organic polymer comprising a nanosized pore with the vanadium salt solution; and
heating the organic polymer impregnated with the vanadium salt solution until the organic polymer is fired.

2. The method of claim 1, wherein the vanadium salt has an oxidation number of one of +2, +3, +4 and +5.

3. The method of claim 1, wherein the vanadium salt solution is a vanadyl sulfate (VOSO₄) solution.

4. The method of claim 1, wherein the vanadium salt solution has a concentration ranging from 5 wt % to 15 wt %.

5. The method of claim 1, wherein the heating the organic polymer is performed at a temperature ranging from 300° C. to 600° C.

6. The method of claim 1, wherein the heating the organic polymer is performed for 30 minutes to 5 hours.

7. The method of claim 1, wherein the heating the organic polymer is performed at a heating rate of 2° C./h to 20° C./h.

8. The method of claim 1, wherein the pore of the organic polymer has a size ranging from 1 nm to 9 nm.

9. The method of claim 1, wherein the vanadium oxide nanoparticles have a size ranging from 50 nm to 90 nm.

10. The method of claim 1, further comprising drying the organic polymer impregnated with the vanadium salt solution before the heating the organic polymer.

11. The method of claim 1, further comprising milling a heating residue after the heating the organic polymer.
